(19) United States
(12) Patent Application Publication
(10) Pub. No.: US 2011/0273508 A1
(43) Pub. Date: Nov. 10, 2011

(54) AQUEOUS INKJET INK

(75) Inventors: Hiroshi Kiyomoto, Kanagawa-ken (JP); Kazuhiko Ohtsu, Shizuoka-ken (JP); Takaya Kitawaki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/095,368

(22) Filed: Apr. 27, 2011

Related U.S. Application Data
(60) Provisional application No. 61/331,114, filed on May 4, 2010.

(51) Int. Cl. B41J 2/015; C09D 11/02

(52) U.S. Cl. 347/20; 106/31.85

(57) ABSTRACT

According to one embodiment, an aqueous inkjet ink includes water in an amount of from 35 to 60% by mass of the total amount, an ether in an amount of from 5 to 50% by mass of the total amount, 2,5,8,11-tetramethyl-6-dodecine-5,8-diol in an amount of from 0.2 to 2% by mass of the total amount, and a pigment in an amount of from 3 to 10% by mass of the total amount. The ether includes at least one of polyoxyethylene diglyceryl ether having a weight average molecular weight of not more than 1,000 and polyoxypropylene diglyceryl ether having a weight average molecular weight of not more than 1,000.

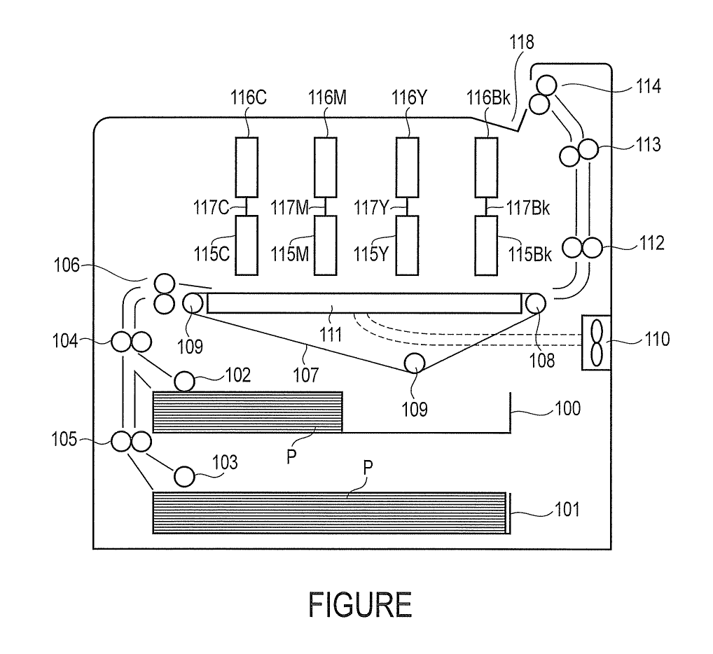

### CROSS-REFERENCE TO RELATED APPLICATIONS

This application is based upon and claims the benefit of priority from U.S. Provisional Application No. 61/331,114 filed on May 4, 2010, the entire contents of which are incorporated herein by reference.

### FIELD

Embodiments described herein relate generally to an aqueous inkjet ink.

### BACKGROUND

In recent years, there are proposed inkjet inks having a pigment dispersed in an aqueous medium. As compared with inks using a water-soluble dye, inks using a pigment are excellent in water resistance and light resistance.

The inkjet inks are required to have characteristics suitable for eject from an inkjet head, for example, resistance to clogging. Inkjet inks for recording on a paper medium are required such that an image with high quality can be formed while reducing deformation of the paper medium, such as curling, to the utmost and that excellent quick-drying properties are revealed.

### BRIEF DESCRIPTION OF THE DRAWINGS

The single FIGURE shows an example of an inkjet recording apparatus to which an embodiment is applied.

### DETAILED DESCRIPTION

In general, according to one embodiment, the aqueous inkjet ink includes water in an amount of from 35 to 60% by mass of the total amount of the aqueous inkjet ink, an ether in an amount of from 5 to 50% by mass of the total amount of the aqueous inkjet ink, 2,5,8,11-tetramethyl-6-dodecine-5,8-diol in an amount of from 0.2 to 2% by mass of the total amount of the aqueous inkjet ink, and a pigment in an amount of from 3 to 10% by mass of the aqueous inkjet ink. The ether includes at least one of polyoxyethylene diglyceryl ether having a weight average molecular weight of not more than 1,000 and polyoxypropylene diglyceryl ether having a weight average molecular weight of not more than 1,000.

Hereinafter, embodiments will be specifically described.

In an inkjet recording apparatus shown in FIGURE, paper cassettes 100 and 101 accommodate papers P having a different size from each other. A paper feed roller 102 or 103 takes out the paper P corresponding to the selected paper size from the paper cassette 100 or 101 and conveys it into conveyance roller pairs 104 and 105 and a resist roller pair 106.

A tension is given to a conveyance belt 107 by a drive roller 108 and two driven rollers 109. Through-holes are provided at prescribed intervals in the conveyance belt 107, and for the purpose of adsorbing the paper P onto the conveyance belt 107, a vacuum chamber 111 connected to a fan 110 is installed in the inside of the conveyance belt 107. Conveyance roller pairs 112, 113 and 114 are installed in the downstream of the paper conveyance direction of the conveyance belt 107.

In an upper part of the conveyance belt 107, four rows of inkjet heads which eject an ink onto paper corresponding to image data are arranged. An inkjet head 115C which ejects a cyan (C) ink, an inkjet head 115M which ejects a magenta (M) ink, an inkjet head 115Y which ejects a yellow (Y) ink and an inkjet head 115Bk which ejects a black (Bk) ink are arranged in this order from the upstream. Furthermore, the inkjet heads 115C, 115M, 115Y and 115Bk are provided with a cyan (C) ink cartridge 116C, a magenta (M) ink cartridge 116M, a yellow (Y) ink cartridge 116Y and a black (Bk) ink cartridge 116Bk, respectively, each accommodating the corresponding ink therein. These cartridges are connected to tubes 117C, 117M, 117Y and 117Bk, respectively.

An image forming operation of the inkjet recording apparatus having such a configuration will be described.

First of all, image processing for recording by an image processor (not illustrated) is initiated, and image data for recording are transferred into the respective inkjet heads 115C, 115M, 115Y and 115Bk. Also, one sheet of the paper P of a selected paper size is taken out each time from the paper cassette 100 or 101 by the paper feed roller 102 or 103 and conveyed to the conveyance roller pairs 104 and 105 and the resist roller pair 106. The resist roller pair 106 corrects a skew of the paper P and conducts the conveyance at a prescribed timing.

The vacuum chamber 111 draws air through the through-holes of the conveyance belt 107, and therefore, the paper P is conveyed in an adsorbed state onto the conveyance belt 107 in a lower side of the inkjet heads 115C, 115M, 115Y and 115Bk. Thus, each of the inkjet heads 115C, 115M, 115Y and 115Bk and the paper P can keep a fixed space from each other. The ink of each color is ejected from the inkjet heads 115C, 115M, 115Y and 115Bk, respectively in synchronism with the timing for conveying the paper P from the resist roller pair 106. Thus, a color image is formed at a desired position of the paper P. The paper P having an image formed thereon is outputted into a paper output tray 118 by the conveyance roller pairs 112, 113 and 114.

Each ink cartridge stores an aqueous inkjet ink according to one embodiment.

A dispersion medium in the aqueous inkjet ink according to the embodiment includes water in an amount of from 35 to 60% by mass of the total amount of the ink, an ether in an amount of from 5 to 50% by mass of the total amount of the ink, and 2,5,8,11-tetramethyl-6-dodecine-5,8-diol in an amount of from 0.2 to 2% by mass of the total amount of the ink. The ether is selected from polyoxyethylene diglyceryl ether having a weight average molecular weight of not more than 1,000 and polyoxypropylene diglyceryl ether having a weight average molecular weight of not more than 1,000.

Since such a dispersion medium is used, when recorded on a paper medium, the aqueous inkjet ink according to the embodiment is excellent in quick-drying properties and is able to form an image with high quality while suppressing curling of the paper medium to the utmost. Moreover, a concern of the generation of clogging of an inkjet head is extremely a little.

In general, the paper medium as referred to in this specification means a medium made of paper to be used for the purpose of being printed. The paper medium is broadly classified into coating papers coated with a material for enhancing printing properties, such as art paper and coated paper, and non-coating papers utilizing characteristics of paper itself. The paper medium is used for various applications to books, publications, newsprint papers, wrapping papers, printer papers and so on. Also, thick papers such as corrugated cardboards, paper-made containers and cardboards are included in the paper medium. So-called plain paper such as copy paper used for copiers or printers which are used in, for example, an office or a household is a typical paper medium.

As described above, in one embodiment, a pigment is dispersed in the dispersion medium containing water, an ether and 2,5,8,11-tetramethyl-6-dodecine-5,8-diol in prescribed amounts, respectively.

The pigment is not particularly limited, and either of an inorganic pigment and an organic pigment may be used. Examples of the inorganic pigment include titanium oxide and iron oxide. Further, a carbon black produced by a known method such as a contact method, a furnace method, or a thermal method can be used.

As the organic pigment, for example, an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, aniline black, or the like can be used.

Specific examples of the carbon black which is used as a black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of which are manufactured by Degussa AG).

Specific examples of the pigment which is used in a yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in a magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in a cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

Since the ink is an inkjet ink, it is preferred that the average particle diameter of such a pigment is within a range of about 10 to 300 nm. It is more preferred that the average particle diameter of the pigment is within a range of about 10 to 200 nm.

The average particle diameter of the pigment can be determined using a particle size distribution analyzer employing a dynamic light scattering method. Examples of the particle size distribution analyzer include HPPS (Malvern Instruments Ltd.).

The pigment can be used in a state of a pigment dispersion. The pigment dispersion can be prepared by, for example, dispersing the pigment in water or an alcohol with a dispersant. Examples of the dispersant include a surfactant, a water-soluble resin, and a water-insoluble resin. Alternatively, a self-dispersible pigment may be used. The self-dispersible type pigment is a pigment which can be dispersed in water or the like without using a dispersant, and to which at least one functional group selected from a carbonyl group, a carboxyl group, a hydroxyl group, and a sulfone group or a salt thereof is bound through a surface treatment. Examples of the surface treatment include a vacuum plasma treatment, a diazo coupling treatment, and an oxidation treatment. The self-dispersible pigment is obtained by grafting a functional group or a molecule containing a functional group on the surface of a pigment through such a surface treatment.

A content of the pigment in the ink is from 3 to 10% by mass of the total amount of the ink. The inkjet ink containing the pigment within the foregoing range is able to form a printed matter having a necessary image density without being accompanied by inconvenience regarding the preservability or ejection performance of the ink. The content of the pigment is preferably from 5 to 7% by mass of the total amount of the ink.

The pigment dispersion is mixed with the dispersion medium containing water, an ether and 2,5,8,11-tetramethyl-6-dodecine-5,8-diol, thereby obtaining the aqueous inkjet ink of the embodiment.

Since the ink is used for inkjet recording, the ink according to the embodiment is required to have an adequate viscosity for eject from a head nozzle in an inkjet printer. Specifically, the viscosity of the ink at 25° C. is preferably from 6 to 15 mPa·s. When the viscosity of the ink at 25° C. is not more than 10 mPa·s, the temperature of the inkjet head at the ejection can be set up relatively low (for example, not higher than about 20° C.).

A content of water is from 35 to 60% by mass of the total amount of the ink. When the content of water is less than 35% by mass, a viscosity falling within an adequate range as the inkjet ink cannot be ensured. For that reason, the ejection ability from the inkjet head is lowered. Meanwhile, when the content of water exceeds 60% by mass of the total amount of the ink, curling of the paper is increased. The content of water is preferably from 40 to 50% by mass of the total amount of the ink. For example, pure water can be used as water.

At least one of ethers including polyoxyethylene diglyceryl ether and polyoxypropylene diglyceryl ether occupies from 5 to 50% by mass of the total amount of the ink. Any of these ethers has a weight average molecular weight of not more than 1,000 and has an action to suppress curling of the paper. When the weight average molecular weight of the ether exceeds 1,000, the ejection stability from the inkjet head is lowered. Taking into consideration the viscosity and storage stability of the ink, the weight average molecular weight of the ether is preferably from 400 to 1,000.

The weight average molecular weight of the polyoxyethylene diglyceryl ether is more preferably from 450 to 700. The weight average molecular weight of the polyoxypropylene diglyceryl ether is more preferably from 400 to 700.

When the amount of the ether is less than 5% by mass of the total amount of the ink, the effect for suppressing curling of the paper is insufficient. Meanwhile, where the amount of the ether exceeds 50% by mass of the total amount of the ink, the viscosity of the ink is high so that the ejection stability from the inkjet head is lowered. The amount of the ether is preferably from 30 to 50% by mass of the total amount of the ink.

The aqueous inkjet ink of the embodiment contains 2,5,8,11-tetramethyl-6-dodecine-5,8-diol in an amount of from 0.2 to 2% by mass of the total amount of the ink. This 2,5,8,11-tetramethyl-6-dodecine-5,8-diol is substantially insoluble in water. When this 2,5,8,11-tetramethyl-6-dodecine-5,8-diol is contained in the ink, the 2,5,8,11-tetramethyl-6-dodecine-5,8-diol acts as a wetting agent as well as a defoaming agent. That is, the 2,5,8,11-tetramethyl-6-dodecine-5,8-diol allows the ink to have favorable wettability, resulting in enhancing the ejection stability from the inkjet head.

When the amount of this 2,5,8,11-tetramethyl-6-dodecine-5,8-diol is less than 0.2% by mass of the total amount of the ink, the desired effects cannot be obtained. Meanwhile, where the amount of the 2,5,8,11-tetramethyl-6-dodecine-5,8-diol exceeds 2% by mass of the total amount of the ink, an undissolved material is produced. The amount of the 2,5,8,11-tetramethyl-6-dodecine-5,8-diol is preferably from 0.2 to 1% by mass of the total amount of the ink.

The aqueous inkjet ink of the embodiment may contain 3-methoxy-3-methyl-1-butanol. The 3-methoxy-3-methyl-1-butanol increases permeability of the ink, thereby further enhancing quick-dry properties and also more reducing curling of the paper. When the 3-methoxy-3-methyl-1-butanol is contained in an amount of from 1 to 25% by mass of the total amount of the ink, the effects are obtained.

Furthermore, by blending an appropriate amount of glycerin in the aqueous inkjet ink of the embodiment, the resistance to clogging is much more enhanced. When the amount of glycerin is excessive, about 20% by mass of the total amount of the ink, it may be difficult to suppress curling of the paper. It is desirable to keep the amount of glycerin to not more than 10% by mass of the total amount of the ink.

In order to much more reduce curling of the paper, it is preferable that the aqueous inkjet ink of the embodiment contains the following compounds.

H(R¹)ₚ—O(CH₂CH₂CH₂O)ₙ—(R²)_{q}H (PPO)

In the foregoing general formula (PPO), R¹ represents —OCH(CH₃)CH₂— or —OCH(CH₂CH₃)CH₂—; R² represents —CH₂CH(CH₃)O— or —CH₂CH(CH₂CH₃)O—; each of p and q represents an integer satisfying 0≦(p+q)≦16; and n represents an integer of from 1 to 16, with a weight average molecular weight of this compound being not more than 1,000.

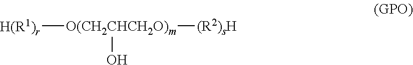

In the foregoing general formula (GPO), R¹ represents —OCH(CH₃)CH₂— or —OCH(CH₂CH₃)CH₂—; R² represents —CH₂CH(CH₃)O— or —CH₂CH(CH₂CH₃)O—; each of r and s represents an integer satisfying 0≦(r+s)≦15; and m represents an integer of from 1 to 13, with a weight average molecular weight of this compound being not more than 1,000.

Such a compound may be called a curling-reducing agent, and when contained in an amount of from about 1 to 10% by mass of the total amount of the ink, the effect is obtained.

The aqueous inkjet ink of the embodiment may contain the following components so far as the characteristics are not impaired. Examples thereof include polyhydric alcohols such as ethylene glycol, diethylene glycol, triethylene glycol, polyethylene glycol, polypropylene glycol, 1,5-pentanediol, 1,6-hexanediol, 1,2,6-hexanetriol, 1,2,4-butanetriol, 1,2,3-butanetriol and petriol; nitrogen-containing heterocyclic compounds such as N-methyl-2-pyrrolidone, N-hydroxyethyl-2-pyrrolidone, 2-pyrrolidone, 1,3-dimethylimidazolidinone and s-caprolactam; amines such as monoethanolamine, diethanolamine, triethanolamine, monoethylamine, diethylamine and triethylamine; sulfur-containing compounds such as dimethyl sulfoxide, sulfolane and thiodiethanol; propylene carbonate, ethylene carbonate and γ-butyrolactone. These compounds act as a wetting agent for preventing drying of the ink from occurring. When a combination of two or more kinds of these compounds is used, the dissolution stability can be enhanced.

A solid wetting agent such as urea, thiourea and ethylene urea may be used in combination with the above-described wetting agent.

In obtaining the aqueous inkjet ink according to the embodiment, for example, the dispersion medium containing water, an ether and 2,5,8,11-tetramethyl-6-dodecine-5,8-diol in prescribed amounts, respectively is mixed with the pigment dispersion. An additive can be added to the dispersion medium, if desired.

For example, an additive such as a surface tension modifier, a viscosity modifier, a pH modifier and a preservative or an antifungal agent can be blended in the aqueous inkjet ink of the embodiment.

Examples of the surface tension modifier include polyoxyethylene alkyl ether acetates, dodecylbenzenesulfonates, lauric acid salts and polyoxyethylene alkyl ether sulfate salts.

A surfactant with water solubility also acts as the surface tension modifier. The water solubility as referred to herein means that 1% by mass or more thereof is soluble in water, and any of nonionic surfactants, acetylene glycol based surfactants or fluorine based surfactants may be useful.

Examples of the nonionic surfactant include polyoxyethylene alkyl ethers, polyoxyethylene alkyl esters, polyoxyethylene sorbitan fatty acid esters, polyoxyethylene alkyl phenyl ethers, polyoxyethylene alkylamines and polyoxyethylene alkylamides.

Examples of the acetylene glycol based surfactant include 2,4,7,9-tetramethyl-5-decine-4,7-diol, 3,6-dimethyl-4-octine-3,6-diol and 3,5-dimethyl-1-hexine-3-ol. Specifically, there are exemplified Surfynol 104, 82, 465, 485 or TG (manufactured by Air Products and Chemicals, Inc.).

Examples of the fluorine based surfactant include a perfluoroalkyl ethylene oxide adduct, a perfluoroalkylamine oxide, a perfluoroalkyl carboxylic acid salt and a perfluoroalkyl sulfonic acid. Specifically, there are exemplified Megafac F-443, F-444, F-470 and F-494 (manufactured by DIC Corporation); Novec FC-430 and FC-4430 (manufactured by 3M Corporation); and Surflon S-141, S-145, S-111N and S-113 (manufactured by Seimi Chemical Co., Ltd.). It is desirable that such a surfactant is added to

an extent that the dispersion stability or the like of the ink is not deteriorated. When the surfactant is contained in a weight of from about 0.2 to 3% by mass of the total amount of the ink, the effects can be exhibited without being accompanied by any inconvenience.

Examples of the viscosity modifier include water-soluble resins such as polyvinyl alcohol, hydroxypropyl cellulose, carboxymethyl cellulose, hydroxyethyl cellulose, methyl cellulose, water-soluble acrylic resins, polyvinylpyrrolidone, gum arabic, dextrin, casein and peptin.

Of these water-soluble resins, for example, water-soluble acrylic resins or the like can be used as a dispersant for preparing the pigment dispersion.

Examples of the pH modifier include potassium dihydrogenphosphate, disodium hydrogenphosphate, sodium hydroxide and triethanolamine.

Examples of the preservative or antifungal agent include sodium benzoate, sodium pentachlorophenol, sodium 2-pyridinethiol-1-oxide, sodium sorbinate, sodium dehydroacetate and 1,2-dibenzisothiazolin-3-one (for example, Proxel CRL, Proxel BDN, Proxel GXL, Proxel XL-2 and Proxel TN, all of which are available from ICI).

By blending such an additive, the quality of printed image and storage stability can be further enhanced.

Hereinafter, specific examples of the aqueous inkjet ink will be described.

Ethers shown in the following Table 1 were prepared.

TABLE 1

| | | Weight average |
|---|---|---|
| Abbreviation | Compound | molecular weight |
| ET1 | Polyoxyethylene | 450 |
| | diglyceryl ether | |
| ET2 | Polyoxyethylene | 1000 |
| | diglyceryl ether | |
| ET3 | Polyoxypropylene | 400 |
| | diglyceryl ether | |
| ET4 | Polyoxypropylene | 1000 |
| | diglyceryl ether | |
| ET5 | Polyoxyethylene | 1500 |
| | diglyceryl ether | |
| ET6 | Polyoxypropylene | 1600 |
| | diglyceryl ether | |

As the compound represented by the general formula (PPO), two kinds of compounds shown in the following Table 2 were used.

H(R¹)ₚ—O(CH₂CH₂CH₂O)ₙ—(R²)_{q}H (PPO)

TABLE 2

| | | | | | | Weight |
|---|---|---|---|---|---|---|
| | | | | | | average |
| | | | | | | molecular |
| Abbreviation | R¹ | R² | p | q | n | weight |
| PPO1 | —OCH(CH₃)CH₂— | —CH₂CH(CH₃)O— | 1 | 1 | 5 | 400 |
| PPO2 | —OCH(CH₃)CH₂— | —CH₂CH(CH₂CH₃)O— | 4 | 5 | 7 | 1000 |

As the compound represented by the general formula (GPO), two kinds of compounds shown in the following Table 3 were used.

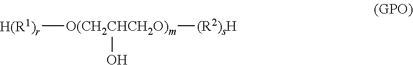

TABLE 3

| | | | | | | Weight average |
|---|---|---|---|---|---|---|
| Abbreviation | R¹ | R² | r | s | m | molecular weight |
| GPO1 | —OCH(CH₃)CH₂— | —CH₂CH(CH₃)O— | 1 | 2 | 3 | 400 |
| GPO2 | —OCH(CH₂CH₃)CH₂— | —CH₂CH(CH₃)O— | 1 | 2 | 11 | 1000 |

These compounds act as the curling-reducing agent.

Respective components were blended according to each of the prescriptions shown in the following Table 4, thereby preparing ink samples. In Table 4, the amount of each of the components is % by mass relative to the total amount of the inkjet ink. As for the ether, the abbreviation shown in the foregoing Table 1 and % by mass are shown. As for the curling-reducing agent, the abbreviation shown in each of the foregoing Tables 2 and 3 and % by mass are shown.

TDD expresses 2,5,8,11-tetramethyl-6-dodecine-5,8-diol; MMB expresses 3-methoxy-3-methyl-1-butanol; and GLC expresses glycerin.

As the pigment dispersion, self-dispersible carbon black was used. Specifically, the used carbon black is CAB-O-JET300 (manufactured by Cabot Corporation). In this pigment dispersion, the carbon black is dispersed in water. An average particle diameter of the carbon black is about 100 nm. The amount of water contained in the pigment dispersion is contained in the amount of water in the following Table 4.

As shown in the following Table 4, in all of the samples, the pigment dispersion was blended in an amount such that the solids content of the pigment was 7% by mass of the total amount of the ink.

Furthermore, in all of the samples, a surfactant in an amount of 1% by mass of the total amount and a preservative in an amount of 0.2% by mass of the total amount were added. Surfynol 465 was used as the surfactant, and Proxel XL-2(S) was used as an antifungal agent.

In preparing an ink sample, first of all, respective components were blended according to each of the prescriptions, and the mixture was stirred with a stirrer for one hour. Thereafter, the resultant was filtered with a 0.8 μm-membrane filter to obtain a sample.

TABLE 4

| | | | | | | Curling- | |
|---|---|---|---|---|---|---|---|
| | | | | | | reducing | |
| No. | Water | Ether | TDD | MMB | GCL | agent | Pigment |
| 1 | 35 | ET1(50) | 0.8 | 6 | — | — | 7 |
| 2 | 46.6 | ET2(45) | 0.2 | — | — | — | 7 |
| 3 | 56.3 | ET3(35) | 0.5 | — | — | — | 7 |
| 4 | 60 | ET4(30) | 0.8 | 1 | — | — | 7 |
| 5 | 45.3 | ET1(20) | 0.5 | 5 | 1 | — | 7 |
| | | ET3(20) | | | | | |
| 6 | 35.8 | ET1(20) | 1 | 10 | 5 | — | 7 |
| | | ET4(20) | | | | | |
| 7 | 35.8 | ET2(35) | 1 | 5 | 5 | PPO1 (10) | 7 |
| 8 | 35.8 | ET3(40) | 1 | 5 | 10 | PPO2 (1) | 7 |
| 9 | 49.8 | ET1(30) | 1 | — | 1 | GPO1 (10) | 7 |
| 10 | 48.8 | ET1(15) | 2 | 4 | 5 | GPO2 (1) | 7 |
| | | ET2(15) | | | | | |
| 11 | 64.8 | ET1(25) | 1 | 1 | — | — | 7 |
| 12 | 69.8 | ET3(20) | 1 | 1 | — | — | 7 |
| 13 | 79.8 | ET2(10) | 1 | 1 | — | — | 7 |
| 14 | 34.8 | ET1(55) | 1 | 1 | — | — | 7 |
| 15 | 44.8 | ET5(45) | 1 | 1 | — | — | 7 |
| 16 | 44.8 | ET6(45) | 1 | 1 | — | — | 7 |
| 17 | 50.8 | ET1(20) | — | 1 | — | — | 7 |
| | | ET3(20) | | | | | |
| 18 | 47.8 | ET1(20) | 3 | 1 | — | — | 7 |
| | | ET3(20) | | | | | |
| 19 | 39.8 | ET1(15) | 1 | 1 | 20 | — | 7 |
| | | ET3(15) | | | | | |

The resulting ink samples were examined with respect to curling-suppressing ability of paper, quality of printing, quick-drying properties and resistance to clogging. The evaluation methods are as follows.

### (Curling-Suppressing Ability)

Plain paper was subjected to solid printing with 100 duty by an inkjet recording apparatus having a Toshiba Piezohead mounted thereon. As for the plain paper, five kinds of paper including Toshiba copy paper, Xerox 4024 paper, Ricoh High-Grade plain paper (type E), Tidal MP paper and NEUSIEDLER paper were used. The paper after printing was placed on a flat desk, and after one minute, a degree of lifting of the four corners of the paper from the face of the desk was measured. An average value of the five kinds of papers was defined as a height of curling and determined according to the following determination criteria.

A: Less than 10 mm

B: 10 mm or more and less than 20 mm

C: 20 mm or more and less than 60 mm

D: 60 mm or more

When the height of curling is less than 10 mm, the curling-suppressing ability is favorable.

### (Quality of Printing)

Plain paper was subjected to character printing using the same inkjet recording apparatus as described above. As for the plain paper, the same five kinds of paper as described above were used. The characters printed were visually evaluated, and the quality of printing such as feathering and strike-through were determined according to the following criteria.

A: Favorable quality of printing is indicated in all of the evaluated papers.

B: A lowering in quality of printing is recognized in one kind of paper among the evaluated paper.

C: A lowering in quality of printing is recognized in from two to three kinds of paper among the evaluated papers.

D: A lowering in quality of printing is recognized in all of the evaluated papers.

When the evaluation grade is A or B, the quality of printing is on an acceptable quality level.

### (Quick-Drying Properties)

A region of 10 mm×10 mm of Toshiba copy paper was subjected to solid printing with 100 duty using the same inkjet recording apparatus as described above. After printing, the printed paper was allowed to stand for a prescribed time. Thereafter, a brand-new Toshiba copy paper was superimposed on the printed portion, and a weight of 300 g was placed thereon. After 10 seconds, the weight was removed, and whether or not the ink was adhered on the brand-new paper was visually examined.

The time of allowing the paper after the solid printing to stand was set to four times of 5 seconds, 10 seconds, 30 seconds and 60 seconds. A degree of adhesion of the ink onto the superimposed paper was visually confirmed and determined according to the following criteria.

A: No adhesion was recognized after 5 seconds.

B: No adhesion was recognized after 10 seconds.

C: No adhesion was recognized after 30 seconds.

D: Adhesion was recognized after 60 seconds.

When the evaluation grade is A or B, the quick-drying properties are on an acceptable quality level.

### (Resistance to Clogging)

Using each of the ink samples, prescribed paper was printed by the above-described inkjet recording apparatus. The inkjet recording apparatus after printing was allowed to stand in an atmosphere at a temperature of 25° C. in a state where the printing head part was taken away from the home position. After one week, the printing test was resumed using the inkjet recording apparatus. The resistance to clogging was evaluated on the basis of a ejected state of the ink from the inkjet head. Evaluation criteria are as follows. A cleaning operation as referred to herein means an operation for removing an ink viscous material adhered in the surroundings of the head nozzle.

A: The ejection was immediately restored without the cleaning operation and became stable.

B: The cleaning operation of the head part of not more than 3 times was required for restoring the ejection.

C: The cleaning operation of the head part of from 4 to 10 times was required for restoring the ejection.

D: The cleaning operation of the head part of 11 or more times was required for restoring the ejection.

When the evaluation grade is A or B, the resistance to clogging is on an acceptable quality level.

The results of the foregoing curling-suppressing ability, quality of printing, quick-drying properties and resistance to clogging are summarized in the following Table 5. A viscosity of each of the ink samples measured at 25° C. using TOKISANGYO's VISCOMETER TV-22 is also shown in the following Table 5.

TABLE 5

| | Curling- | | | | |
|---|---|---|---|---|---|
| | suppressing | Quality of | Quick-drying | Resistance to | Viscosity |
| No. | ability | printing | properties | clogging | (mPa · s) |
| 1 | A | A | A | B | 15 |
| 2 | A | A | B | B | 9.2 |
| 3 | A | A | B | B | 8.1 |
| 4 | A | B | A | B | 6 |
| 5 | A | A | A | A | 10.3 |
| 6 | A | A | A | A | 14.7 |
| 7 | A | A | A | A | 14.4 |
| 8 | A | B | A | A | 13.9 |
| 9 | A | A | B | A | 8.7 |
| 10 | A | A | A | A | 9.5 |
| 11 | C | A | B | C | 5.6 |
| 12 | D | A | B | D | 4.5 |
| 13 | D | A | B | D | 3.8 |
| 14 | B | C | D | B | 28.4 |
| 15 | A | B | A | D | 11.7 |
| 16 | A | B | A | D | 12 |
| 17 | B | C | B | B | 8.8 |
| 18 | B | B | A | D | 9.3 |
| 19 | D | B | B | A | 13.5 |

As shown in the foregoing Table 5, the ink samples Nos. 1 to 10 are on an acceptable quality level with respect to all of the curling-suppressing ability, quality of printing, quick-drying properties and resistance to clogging. Moreover, the ink samples

Nos. 1 to 10 have a viscosity at 25° C. falling within the range of from 6 to 15 mPa·s and are adequate as an inkjet ink. In these ink samples, water, the ether and 2,5,8,11-tetramethyl-6-dodecine-5,8-diol are contained in prescribed amounts, respectively. Above all, the ink samples Nos. 5 to 7 and 9 in which 3-methoxy-3-methyl-1-butanol and glycerin are further contained are on the grade “A” in all of the evaluations and exhibit especially excellent characteristics.

The ink samples Nos. 11 to 13 are inferior in the curling-suppressing ability and resistance to clogging. In these ink samples, it is shown in the foregoing Table 4 that the content of water exceeds 50% by mass. Meanwhile, the ink sample No. 14 is inferior in the quality of printing and quick-drying properties and has a large viscosity at 25° C. as 28.4 mPa·s. The reason why the performance of the ink sample No. 14 is low is caused due to the fact that the content of water is small as shown in the foregoing Table 4.

The ink samples Nos. 15 and 16 are conspicuously inferior in the resistance to clogging. In these ink samples, water, the ether and 2,5,8,11-tetramethyl-6-dodecine-5,8-diol are contained in prescribed amounts, respectively. However, the ether contained in each of these ink samples is ET5 and ET6, respectively as shown in Table 4. It is noted from these results that when the weight average molecular weight of the ether exceeds 1,000, the resistance to clogging is lowered.

The results of the ink sample No. 17 reveal that when 2,5,8,11-tetramethyl-6-dodecine-5,8-diol is not contained, the quality of printing is inferior. Meanwhile, the results of the ink sample No. 18 reveal that when 2,5,8,11-tetramethyl-6-dodecine-5,8-diol is contained excessively, the resistance to clogging is inferior.

As shown in the ink sample No. 19, when the amount of glycerin is 20% by mass, the curling-suppressing ability is not obtained.

By containing water, an ether having a weight average molecular weight of not more than 1,000 and 2,5,8,11-tetramethyl-6-dodecine-5,8-diol in prescribed amounts, aqueous inkjet inks with desired characteristics were obtained.

The aqueous inkjet ink of the embodiment is excellent in resistance to clogging and also, when recorded on a paper medium, has favorable quick-drying properties and is able to form an image with high quality while reducing deformation of the paper medium, such as curling, to the utmost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An aqueous inkjet ink comprising:
water in an amount of from 35 to 60% by mass of a total amount of the aqueous inkjet ink;
an ether in an amount of from 5 to 50% by mass of the total amount of the aqueous inkjet ink, the ether comprising at least one of polyoxyethylene diglyceryl ether having a weight average molecular weight of not more than 1,000 and polyoxypropylene diglyceryl ether having a weight average molecular weight of not more than 1,000;
2,5,8,11-tetramethyl-6-dodecine-5,8-diol in an amount of from 0.2 to 2% by mass of the total amount of the aqueous inkjet ink; and
a pigment in an amount of from 3 to 10% by mass of the total amount of the aqueous inkjet ink.

2. The ink according to claim 1, wherein the amount of water is from 40 to 50% by mass of the total amount of the aqueous inkjet ink.

3. The ink according to claim 1, wherein the amount of the ether is from 30 to 50% by mass of the total amount of the aqueous inkjet ink.

4. The ink according to claim 1, wherein the weight average molecular weight of the polyoxyethylene diglyceryl ether is 450 or more.

5. The ink according to claim 1, wherein the weight average molecular weight of the polyoxyethylene diglyceryl ether is 700 or less.

6. The ink according to claim 1, wherein the weight average molecular weight of the polyoxypropylene diglyceryl ether is 400 or more.

7. The ink according to claim 1, wherein the weight average molecular weight of the polyoxypropylene diglyceryl ether is 700 or less.

8. The ink according to claim 1, wherein the amount of the 2,5,8,11-tetramethyl-6-dodecine-5,8-diol is from 0.5 to 1% by mass of the total amount of the aqueous inkjet ink.

9. The ink according to claim 1, further comprising 3-methoxy-3-methyl-1-butanol.

10. The ink according to claim 9, wherein an amount of the 3-methoxy-3-methyl-1-butanol is from 1 to 25% by mass of the total amount of the aqueous inkjet ink.

11. The ink according to claim 1, further comprising glycerin in an amount of not more than 10% by mass of the total amount of the aqueous inkjet ink.

12. The ink according to claim 1, further comprising a compound represented by the following general formula (PPO):
H(R¹)ₚ—O(CH₂CH₂CH₂O)ₙ—(R²)_{q}H (PPO)
wherein
R¹ represents —OCH(CH₃)CH₂— or —OCH(CH₂CH₃)CH₂—,
R² represents —CH₂CH(CH₃)O— or —CH₂CH(CH₂CH₃)O—,
each of p and q represents an integer satisfying 0≦(p+q)₁₆, and
n represents an integer of from 1 to 16, with a weight average molecular weight being not more than 1,000.

13. The ink according to claim 12, wherein an amount of the compound represented by the general formula (PPO) is from 1 to 10% by mass of the total amount of the aqueous inkjet ink.

14. The ink according to claim 1, further comprising a compound represented by the following general formula (GPO): 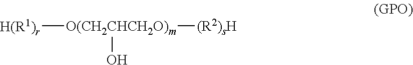
wherein
R¹ represents —OCH(CH₃)CH₂— or —OCH(CH₂CH₃)CH₂—,
R² represents —CH₂CH(CH₃)O—or —CH₂CH(CH₂CH₃)O—,
each of r and s represents an integer satisfying 0≦(r+s)≦15, and
m represents an integer of from 1 to 13, with a weight average molecular weight being not more than 1,000.

15. The ink according to claim 14, wherein an amount of the compound represented by the general formula (GPO) is from 1 to 10% by mass of the total amount of the aqueous inkjet ink.

16. The ink according to claim 1, wherein the pigment is a self-dispersible pigment.

17. A method for inkjet printing comprising:
ejecting at least one type of ink composition from an inkjet head onto a paper medium to form an image, the ink composition being the aqueous inkjet ink according to claim 1.

18. The method according to claim 17, wherein the image is formed using one type of ink composition.

19. The method according to claim 17, wherein the image is formed using two or more types of ink compositions of different colors.
